(19) United States
(12) Patent Application Publication
(10) Pub. No.: US 2025/0384135 A1
(43) Pub. Date: Dec. 18, 2025

(54) METHODS AND SYSTEMS FOR SECURELY MODIFYING HARDWARE COMPONENTS OF ELECTRONIC SYSTEMS

(71) Applicant: Schlage Lock Company LLC, Carmel, IN (US)

(72) Inventors: Dan Pfunder, Noblesville, IN (US); Kevin P. Oehler, Fishers, IN (US); Jonathan Everson, Kokomo, IN (US); John Goodrich, Carmel, IN (US)

(21) Appl. No.: 18/741,335

(22) Filed: Jun. 12, 2024

(51) Int. Cl. G06F 21/57

(52) U.S. Cl. CPC G06F 21/572

(57) ABSTRACT

A system and method for updating configurable hardware components of electronic systems wherein each configurable hardware component has a discoverable common memory region that includes specific identification information for the associated hardware component. Each common memory region can be surveyed in connection with generating a survey report that can be communicated to an external hardware management system that is remote from, and/or external to, the product. Using the identification information provided by the survey report, the external hardware management system can determine customized, and compatible, updated firmware for the electronic system, thereby minimizing the amount of firmware stored on the product. A variety of security measures can be also utilized to prevent unauthorized changes to the hardware components of the system. The survey report can be compared by a controller of the electronic system to a stored hardware inventory in connection with detecting at least potential tampering with the product.

### TECHNICAL FIELD

The present disclosure generally relates to electronic systems having a collection of configurable hardware components, and more particularly, but not exclusively, to methods and systems for discovering, initializing, and configuring hardware components of a product that supports in-field upgrades, including modular replacement of a selected hardware component(s).

### BACKGROUND

The electronic system for a variety of products can include a plurality of configurable hardware components, including, but not limited to printed circuit board assemblies, such as, but not limited to, electronic hardware modules and circuitry assemblies. The complexity of such electronic systems, including with respect to the number of the configurable hardware components, as well as the compatibilities of the firmware, or firmware combinations, for such hardware components of the electronic system can present obstacles at least in terms of upgrading or repairing those hardware components and/or electronic systems in the field.

One approach to address such issues is for the associated electronic system to store firmware, and more specifically, firmware packages or images, and/or software for generally all hardware configurations or variations that may be possible for the electronic system. Thus, a significant amount of the memory of the electronic system can be devoted to storing a relatively large amount of firmware that may never actually be used by, or applicable to, that particular product. As any new features are introduced, all updatable portions of the electronic system, the configurable hardware components, may be updated so as to maintain a consistent interface to the firmware and/or the associated software. Yet, such an approach can be expensive, create complex issues, and also fail to scale.

Another approach can be to reduce the amount of firmware and/or software that are to be stored by the system by limiting the number of possible hardware configurations or variations, including, for example, by having certain hardware components be configured to not be updatable. Yet, the inability to update certain hardware components can limit the ability to customize, add, or change certain features of the electronic system and associated product, and can make the electronic system difficult to scale.

Further, certain approaches rely on the user of the associated product to manually update the electronic system. Yet, such an approach is at least partially dependent on the user, who may have limited experience with configuring electronic systems, accurately identifying the hardware configuration, as well as correctly performing the associated update of the electronic system.

### SUMMARY

The present disclosure may comprise one or more of the following features and combinations thereof.

In one embodiment of the present disclosure, a system is provided that can include a door lock assembly and an electronic system, and wherein the electronic system can be housed within at least a portion of the door lock assembly. The electronic system can include a plurality of configurable hardware components having at least a common memory region, at least one processor, and a memory coupled with the at least one processor. The memory can include instructions that when executed by the at least one processor cause the at least one processor to discover the common memory region for each configurable hardware component of the plurality of configurable hardware components and survey the common memory region of each configurable hardware component of the plurality of configurable hardware components for an identifier. Additionally, the memory can also include instructions that when executed by the at least one processor cause the at least one processor to transmit a survey report for an external hardware management system that is external to the door lock assembly that identifies each of the plurality of configurable hardware components based at least in part on the identifier. Further, the memory can include instructions that when executed by the at least one processor cause the at least one processor to receive an updated firmware generated by the external hardware management system that is based on the combination of the plurality of configurable hardware components identified by the survey report, and install the updated firmware on each of the plurality of configurable hardware components.

In another embodiment, a system is provided for an electronic system housed within at least a portion of a product. The electronic system can include a plurality of configurable hardware components, each of the plurality of configurable hardware components having at least a common memory region. The electronic system can also include at least one processor and a memory coupled with the at least one processor. The memory can include instructions that when executed by the at least one processor cause the at least one processor to discover, in response to a trigger event, the common memory region for each configurable hardware component of the plurality of configurable hardware components, and survey the common memory region of each configurable hardware component of the plurality of configurable hardware components for an identifier. The memory can also include instructions that when executed by the at least one processor cause the at least one processor to generate a survey report that identifies each of the plurality of configurable hardware components based at least in part on the identifier and compare the survey report to a hardware inventory stored by the electronic system. Additionally, the memory can include instructions that when executed by the at least one processor cause the at least one processor to identify, in response to at least an identification of a difference between the survey report and the hardware inventory, a stored information indicative of the product undergoing an authorized upgrade sequence, and transmit, in response to at least identification of the stored information indicative of the authorized upgrade sequence, the survey report for an external hardware management system that is external to the product. Further, the memory can include instructions that when executed by the at least one processor cause the at least one processor to receive an updated firmware generated by the external hardware management system that is based on the combination of the plurality of configurable hardware components identified by the survey report, and install the updated firmware on each of the plurality of configurable hardware components.

In another embodiment of the present disclosure a method is provided that can include discovering, using a controller of a product, a common memory region for each of a plurality of configurable hardware components of an electronic system of the product, and surveying, using the controller, the discovered common memory region of each configurable hardware component of the plurality of configurable hardware components for an identifier. Additionally, a survey report can be transmitted from the electronic system during a first communication connection for an external hardware management system that is external to the product. The survey report can identify each of the plurality of configurable hardware components based at least in part on the identifier. The method can also include receiving, by the electronic system, an updated firmware generated by the external hardware management system that is based on the combination of the plurality of configurable hardware components identified by the survey report, and installing the updated firmware on each of the plurality of configurable hardware components.

These and other features of the present disclosure will become more apparent from the following description of the illustrative embodiments.

### BRIEF DESCRIPTION OF THE FIGURES

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a simplified block diagram of a configurable electronic system of a product in the form of a door lock assembly that is coupled to a door.

FIG. 2 illustrates a simplified block diagram of a system including the exemplary door lock assembly and an external hardware management system according to an embodiment of the subject disclosure.

FIGS. 3A and 3B illustrate a simplified flow diagram of an exemplary method 300 for modifying a configurable electronic system according to an exemplary embodiment of the subject application.

FIG. 4 illustrates a simplified block diagram depicting communications and features relating to the exemplary configurable hardware components of the electronic system of the illustrated product and an associated external hardware management system.

### DETAILED DESCRIPTION OF THE ILLUSTRATIVE EMBODIMENTS

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

In the Detailed Description herein, references to “one embodiment”, an “embodiment”, and “example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

Embodiments of the subject disclosure provide methods and systems for the discovery of features pertaining to a collection of configurable hardware components of an electronic system, performance of safe initialization of those hardware components, configuration of software, including firmware, capabilities to match the hardware components, and support for in-field, and modular, upgrade and/or replacement of those hardware components.

Additionally, embodiments of the subject disclosure provide systems and methods for creating and supporting configurable electronic systems in a manner that provides safe initialization, secure feature discovery, and upgrade operations of at least configurable hardware components with minimal utilization of firmware and hardware resources. Further, the systems and methods disclosed herein provide improvement at least with respect to supporting variable hardware configurations in software, including firmware, as the disclosed approaches do not require knowledge of current future variations in the electronic system, can guard against unexpected updates to the electronic system, and can avoid introduction of security vulnerabilities that can be inherent for other, traditional upgrade solutions.

According to certain embodiments of the subject disclosure, each configurable hardware component of the electronic system can include a generally standardized small memory location that can be discoverable and surveyed by one or more controllers of the electronic system, including, for example, one or more of a product main controller and/or sub-system controller(s), to identify the configurable hardware component, including type or other characterization of hardware component, a unique identifier for the hardware component, a description or other information of how to safely initiate the hardware component, and a scratchpad area for the controller to perform authentication sequences. Critical information regarding the surveyed configurable hardware components can be passed to an external hardware management system, including, for example, the cloud or other external device, such as, for example, a client software system(s) or computing device, for processing. Such an external hardware management system can contain one or more algorithms configured for selecting the proper, including correct, firmware revisions to install in one or more of the surveyed hardware components, proper firmware configurations, and any other software configuration that may best for the hardware component, among other memory content devices, to support the electronic system.

The combination of discoverable hardware components using defined memory structures, including common memory regions for each discovered configurable hardware component, coupled with an external hardware management system can, compared to traditional approaches, simplify the activities of initialization, feature discovery, and upgrade. Such an approach can be designed to utilize the least amount of pre-configured knowledge of possible variations in the firmware design, and can also be designed to safely initialize the associated electronic system while the external hardware management system configures the product according to the combination of at least the surveyed hardware components. This concept of a hardware component memory location in the form of a common memory region can also be beneficial to facilitating selective upgrades to one or more of the hardware components in the field. Further, with such an approach, the algorithmic complexity of establishing the proper firmware and proper configurations for the electronic system of the product can be the responsibility of the external hardware management system, including, for example, the cloud. Such an arrangement of responsibilities can provide an efficient firmware solution, accommodate a larger number of supportable electronics variations, and provide a relatively high level of security during commissioning of new product configurations or hardware upgrades.

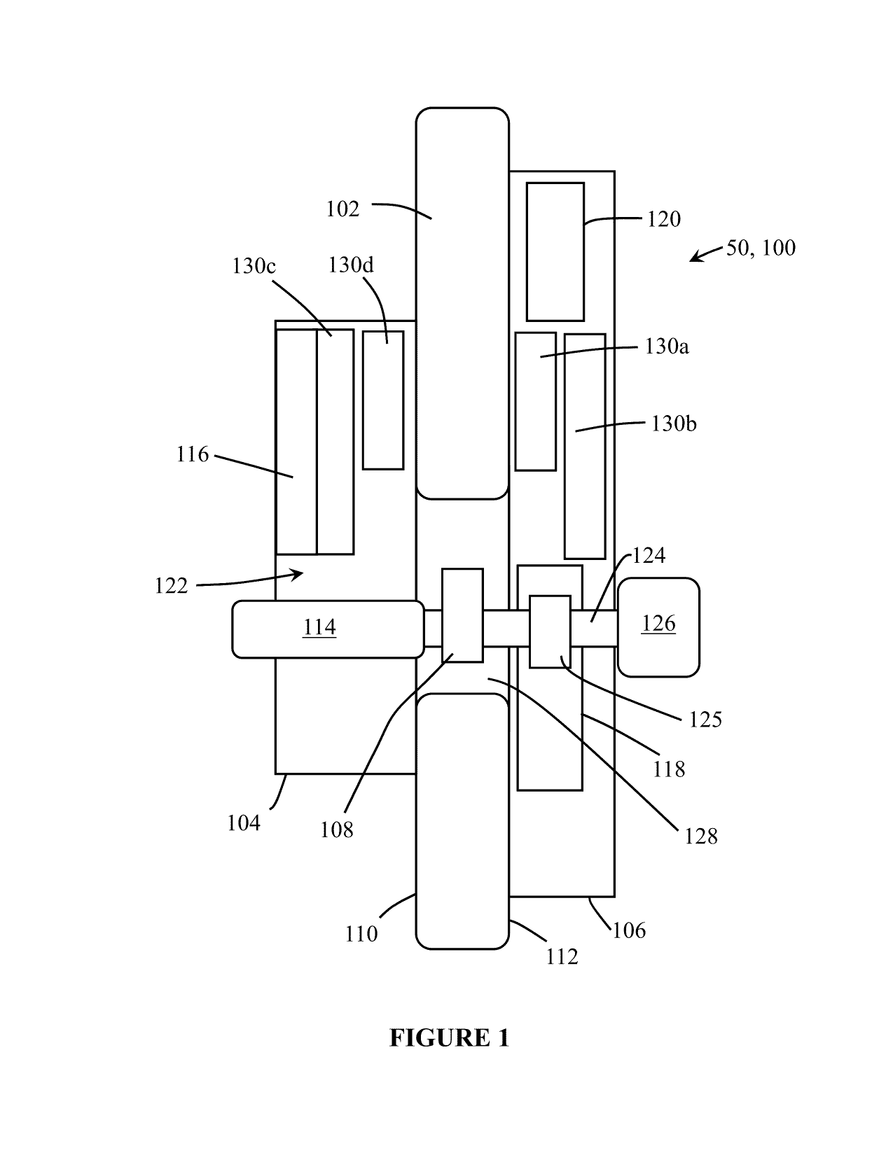

FIG. 1 illustrates a simplified block diagram of an electronic assembly for a product 50 in the form of an electronic door lock assembly 100 that is coupled to a door 102. While exemplary embodiments are discussed herein with regard to an electronic door lock assembly 100, embodiments of the subject application are also applicable to other types of electronic systems for a variety of different types of products that may or may not be related to locks or access control devices. Moreover, the subject disclosure is applicable to a wide range of electronic systems having configurable hardware components, also referred to herein as printed circuit board assemblies (PCBAs), which can include, for example, electronic hardware modules and circuitry assemblies. For example, the embodiments of the subject application are also applicable to other types of electronic systems for products such as, for example, relating to readers, reader-controllers, communication gateways, and automated operators, among a wide variety of other products.

As seen in FIG. 1, the door lock assembly 100 includes a first or outer escutcheon 104, a second or inner escutcheon 106, and bolt portion 108. The outer and inner escutcheons 104, 106 can be configured to be adjacent to, or abut, a first, outer side 110 and second, inner side 112, respectively, of the door 102. According to certain embodiments, the outer escutcheon 104 can include a key cylinder 114 having a keyhole configured to receive a key that, when operably positioned within the keyhole, can be used to manipulate a bolt of the bolt portion 108 between extended and retracted positions in connectionwith selectively securing/opening the door 102 about, for example, a door jam. The outer escutcheon 104 can additionally, or alternatively, include a credential portion 116, such as, for example, keypad or credential reader, among other types of credential or detection devices. In response to proper credential data, including authentication information, being inputted, detected, and/or retrieved/received at, by, or through the credential portion 116, an actuator 118, such as, for example, a motor, of the door lock assembly 100 can be activated that can facilitate the bolt of the bolt portion 108 being displaced to the retracted/unlocked or extended/locked position.

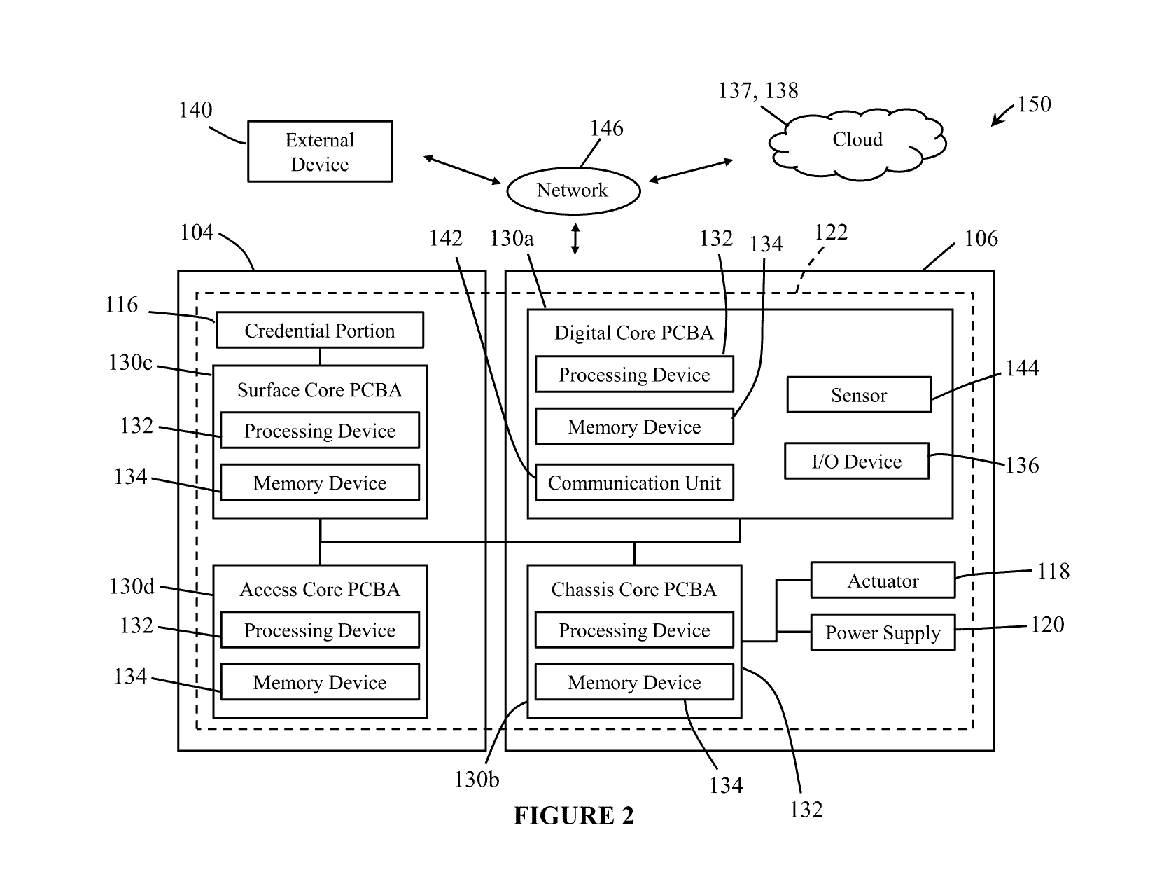

According to certain embodiments, the inner escutcheon 106 can be structured to receive a power source 120, such as, for example, one or more batteries, that can provide power or energy for at least one or more of the actuator 118 and the credential portion 116, among other components of an electronic system 122 (FIG. 2) of the door lock assembly 100. However, the door lock assembly 100 can utilize a variety of other power sources in addition to, or in lieu of batteries. Moreover, the powered module can include an energy source for powering the actuator 118 that directly or indirectly provides a force, such as, for example, to a driver 124, that can be directly or indirectly transmitted for the displacement of the bolt of the bolt portion 108. Additionally, the thumb turn 126 can be directly or indirectly coupled to the bolt of the bolt portion 108, driver 124, and/or one or more clutches 125 such that operation of the thumb turn 126 can provide a force used for at least displacing the bolt to the extended or retracted position, or vice versa.

The bolt portion 108 can include a housing for enclosing at least a portion of the bolt, as well as a bolt driving mechanism that can be interposed between the bolt and the driver 124. At least a portion of the bolt portion 108 is configured for placement within a cross bore 128 within the door 102.

FIG. 2 illustrates a simplified block diagram of a system 150 that includes the product 50 (e.g., door lock assembly 100) and an external hardware management system 137 according to an embodiment of the subject disclosure. The electronic system 122 includes a plurality of configurable hardware components, which, in the exemplary embodiment, comprises a plurality of printed circuit board assemblies (PCBAs) 130a-d, which can also be identified using a variety of other terminology, including, but not limited to, circuity assembly or electronic hardware module, among other terms. As seen in FIG. 2, the product 50 includes at least the electronic system 122, which, in the illustrated example, can be located at least at a portion(s) of either or both the outer escutcheon 104 and the inner escutcheon 106. Moreover, according to the illustrated embodiment, one or more of the PCBAs 130a, 130b can be part of, including, for example, positioned within a portion of, the inner escutcheon 106, while one or more other PCBAs 130c, 130d can be part of the outer inner escutcheon 106. The PCBAs 130a-d can each include at least one processing device 132, as well as at least one memory device 134. Moreover, one or more, if not all, of the PCBAs 130a-d may, or may not, include a processing device 132. Thus, according to certain embodiments, some, but not necessarily all, of the PCBAs 130a-d may not include a processing device 132, while other PCBAs 130a-d may include a processing device 132. Further, each of the PCBAs 130a-b can be utilized in connection with different functionalities of the door lock assembly 100 and/or support the functionality provided by another PCBA 130a-d.

The processing device 132 can be embodied as any type of processing device 132(s) capable of performing the functions described herein. In particular, the processing device 132 may be embodied as one or more single or multi-core processing device 132s, microcontrollers, or other processing device 132 or processing/controlling circuits. For example, in some embodiments, the processing device 132 may include or be embodied as an arithmetic logic unit (ALU), central processing unit (CPU), digital signal processing device (DSP), Field Programmable Gate Array (FPGA), Complex Programmable Logic Device (CPLD), and/or another suitable processing device 132(s). The processing device 132 may be a programmable type, a dedicated hardwired state machine, or a combination thereof. Processing devices 132 with multiple processing units may utilize distributed, pipelined, and/or parallel processing in various embodiments. Further, the processing device 132 may be dedicated to performance of just the operations described herein, or may be utilized in one or more additional applications. In the illustrative embodiment, the processing device 132 is of a programmable variety that executes algorithms and/or processes data in accordance with operating logic as defined by programming instructions (such as software or firmware) stored in the memory device 134. Such operation by the processing device 132 can include, for example, an interpretation of one or more encoded data fields by one or more programs or software running on the processing device 132. Additionally, or alternatively, the operating logic for processing device 132 may be at least partially defined by hardwired logic or other hardware. Further, the processing device 132 may include one or more components of any type suitable to process the signals received from input/output (I/O) device 136 or from other components or devices and to provide desired output signals. Such components may include digital circuitry, analog circuitry, or a combination thereof.

The memory device 134 may be of one or more types of non-transitory computer-readable media, such as a solid-state memory, electromagnetic memory, optical memory, or a combination thereof. Furthermore, the memory device 134 may be volatile and/or nonvolatile and, in some embodiments, some or all of the memory device 134 may be of a portable variety, such as a disk, tape, memory stick, cartridge, and/or other suitable portable memory. In operation, the memory device 134 may store various data and software used during operation of the electronic system 122 and/or door lock assembly 100 such as operating systems, applications, programs, libraries, and drivers. It should be appreciated that the memory device 134 may store data that is manipulated by the operating logic of processing device 132, such as, for example, data representative of signals received from and/or sent to the I/O device 136 in addition to or in lieu of storing programming instructions defining operating logic. As shown in FIG. 2, the memory device 134 may be included with the processing device 132 and/or coupled to the processing device 132 depending on the particular embodiment. For example, in some embodiments, the processing device 132, the memory device 134, and/or other components of the electronic system 122 and/or door lock assembly 100 may form a portion of a system-on-a-chip (SoC) and be incorporated on a single integrated circuit chip.

The memory device 134 can be embodied as any type of volatile (e.g., dynamic random-access memory (DRAM), etc.) or non-volatile memory capable of storing data therein. Volatile memory may be embodied as a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM).

In some embodiments, the memory device 134 can be embodied as a block addressable memory, such as those based on NAND or NOR technologies. The memory device 134 can also include future generation nonvolatile devices, such as a three-dimensional crosspoint memory device (e.g., Intel 3D XPoint™ memory), or other byte addressable write-in-place nonvolatile memory devices. In some embodiments, the memory device 134 can be embodied as, or may otherwise include, chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device 134 can refer to the die itself and/or to a packaged memory product. In some embodiments, 3D crosspoint memory (e.g., Intel 3D XPoint™ memory) can comprise a transistor-less stackable cross point architecture in which memory cells sit at the intersection of word lines and bit lines and are individually addressable and in which bit storage is based on a change in bulk resistance.

The electronic system 122 can also include other or additional components, such as those commonly found in a typical computing device (e.g., various input/output devices and/or other components). It should be further appreciated that one or more of the components of the electronic system 122 and/or product described herein may be distributed across multiple computing devices or electronic systems. In other words, the techniques described herein may be employed by a computing system that includes one or more computing devices. Additionally, although only a single processing device 132 and memory device 134 are illustratively shown for each of the configurable hardware components, namely the PCBAs 130a-d shown in FIG. 2, it should be appreciated that a PCBA 130a-d, among other components of the electronic system 122 and/or product 50, may include multiple processing devices 132, and/or memory devices 134 in other embodiments. Further, according to certain embodiments, one or more of the PCBAs 130a-d may not include a processing device 132. Additionally, to the extend a PCBA 130a-d does not include a processing device 132, the PCBA 130a-d can still include one or more memory devices 134. Further, in some embodiments, one or more external devices may be in communication with the electronic system 122 and/or door lock assembly 100.

While the exemplary electronic system 122 shown in FIG. 2 is illustrated as having four configurable hardware components, namely the four PCBAs 130a-d, the number or quantity of configurable hardware components can vary for different embodiments. Additionally, the structure, components, features, capabilities, and/or functions, among other characteristics, of the configurable hardware components can vary among the configurable hardware components of the same electronic system 122, as well as among different electronic systems and/or products 50.

The memory device 134 and/or processing device 132 of each configurable hardware component, or PCBA 130a-d in this example, can be configured to provide, or reserve, a small accessible memory region that provides a defined common memory region that can be utilized in connection with reporting a configuration and an identity of the PCBA 130a-d to the electronic system 122, or portions thereof, including to one or more other PCBAs 130a-d. Moreover, such defined common memory regions may also, for example, be either, or part of, independent memories or integrated memories. The common memory region for each PCBA 130a-d can include a variety of identification information that can identify the associated PCBA 130a-d, including, for example, the hardware and/or module type, part number, manufacturing location, manufacturing date, revision, and/or unique serial number of the PCBA 130a-d, among other information that may be relevant to the identification, discovery, updating, and configuration solutions discussed herein. Further, the structure for such a common memory region can vary for different configurable hardware components.

The memory device 134 of the configurable hardware components, or PCBA 130a-d in this example, can also include at least basic information that can indicate how the associated product 50 can be configured for safe operation, such as, for example, operation with partial, but not full, functionality, of the product 50, also referred to herein as safe operation, with the inclusion of the associated configurable hardware component. For example, as discussed herein, in certain instances, one or more configurable hardware components may be added to a product, including, for example, in connection with a repair or upgrade of the product 50. At least until the addition of such a new or replacement configurable hardware component(s) is authenticated as being authorized, as discussed herein, the memory device 134 of the new or replacement hardware component can include some basic configuration data information that can be provided to one or more processing devices 132 of the associated product 50, including, but not limited to, a main processing element (e.g. the controller or first PCBA 130a), if any, among other elements of the distributed system. In such situations, the configuration data can provide information as to how to configure the product 50 with the inclusion of the new or replacement configurable hardware component(s) in a manner that can safely accommodate safe operation of the product 50, including at least partial, but not necessarily full, functionality of the product 50 at least until the modification involving the new or replacement configurable hardware component(s) can be authenticated as being authorized.

According to certain embodiments, the basic configuration information provided by the new or replacement configurable hardware component(s) that can accommodate the safe operation of the product 50 can also include information that can instruct the main processing element (e.g. the controller or first PCBA 130a) how to discover other new or replacement items, including other configurable hardware component(s), that may also be connected to the product 50, including, but not limited to, connected to the new or replacement configurable hardware component(s) that provided the basic configuration information. Additionally, or alternatively, receipt of the basic configuration information provided by the new or replacement configurable hardware component(s) can trigger the main processing element (e.g., the controller or first PCBA 130a) to conduct additional discovery or queries to identify other new or replacement configurable hardware component(s) that may be connected to the product.

The common memory region can also store information regarding the associated hardware component that can be utilized in evaluating warranty claims, including, for example, information identifying a date of, or time period since, installation or initial use of the PCBA 130a-d and/or the underlying product 50, and as well as the extent and nature of the use. Additionally, with respect to embodiments in which this defined common memory region is part of a memory device 134, other portions of the memory device 134 for each of the PCBAs 130a-d can also store a variety of other information, including, but not limited to, information that can aid diagnostic investigations and to help hardware upgrade procedures, among other information.

With respect to one or more, if not all, of the PCBAs 130a-d, all of the capabilities of the PCBA 130a-d may not be directly enunciated within the associated memory device 134 of that PCBA 130a-d. For example, as discussed below, according to certain embodiments, rather than have the PCBAs 130a-d self-discover and adjust for the capabilities of other PCBAs 130a-d, an external hardware management software system 137 can be used to establish the product 50 or PCBA 130a-d capabilities based on the types and revisions of PCBAs 130a-d, and configure the PCBAs 130a-d appropriately. Such an external hardware management system 137 can reside at a variety of locations, or combination of locations, including, for example, on a cloud-based system (also referred to herein as cloud 138), client computing device, or client software system, among other locations.

As also discussed below, use of the external hardware management system 137 to modify, including repair or replace or otherwise upgrade, one or more hardware components of the electronic system 122, including one or more PCBAs 130a-d may be prevented, and thus unsuccessful, if the external hardware management system 137 cannot authenticate the modification as a credible or authorized upgrade sequence. Such an approach can be utilized to prevent illicit or other unauthorized hardware changes. Additionally, according to certain embodiments, one or more processing devices of the electronic system 122, including the processing device 132 of one or more of the PCBAs 130a-d can periodically, including, but not limited to, at scheduled or random time periods or in response to predetermined trigger or milestone events, can be used to read or survey the content contained on the common memory regions of discovered configurable hardware components of the electronic system 122 to establish whether an unexpected or unauthorized hardware modification(s) has/have, or has/have not occurred. The electronic system 122, including a controller of the electronic system 122, which can, according to certain embodiments, be provided by at least one configurable hardware component (e.g., a first PCBA 130a) can further be configured to, in response to detection of an unexpected or unauthorized modification to a configurable hardware component and/or the electronic system 122, operate the product 50 in a limited capacity and/or power down the product 50. Further, in such situations the limited, if any, operability of the product 50 may continue at least until at least the electronic system 122 configuration that existed prior to the unexpected or unauthorized modification is restored.

In the illustrated exemplary embodiment in which the configurable hardware components comprise a plurality of PCBAs 130a-d, a first PCBA 130a can, for example, be a digital core PCBA. According to such the first PCBA 130a can be a driver PCBA, and, moreover, can at least provide or function as a controller from the electronic system. Thus, in the illustrated example in which the product 50 is a door lock assembly 100, the first PCBA 130a can be responsible for access decisions, including, for example, decisions relating to whether the actuator 118 is to be activated to displace the bolt of the bolt portion 108 from at least an extended/locked position to a retracted/unlocked position. Further, as the controller, the illustrated first PCBA 130a can also be configured to reading and storing all memory device 134 memories for the electronic system 122, including the memories from the memory devices 134 of each of the plurality of PCBAs 130a-d. Thus, the first PCBA 130a in the illustrated example, can be configured to communicate with any other PCBA 130b located on the same side of the door 102 as the first PCBA 130a (e.g., part of the inner escutcheon 106), as well as with other PCBAs 130c, 130d that may be located on the opposite side of the door 102 (e.g., part of the outer escutcheon 104).

Additionally, the first PCBA 130a can also be configured to coordinate upgrade sequences for the product 50 relating to, for example, upgrades, replacements, and/or repairs of one or more of the PCBAs 130a-d, among other hardware of the electronic system 122. The coordinating of the upgrade sequence by the first PCBA 130a can also include the first PCBA 130a directly or indirectly communicating with the external hardware management system 137, including, for example, the cloud 138. Thus, the first PCBA 130a can include a communication device, component(s) and/or circuitry (generally collectively referred to as a “communication device” 142) that is configured to secure communications between the electronic system 122 and the external hardware management system 137 and/or an external device 140, including, for example, a computing device, such as, but not limited to, a mobile computing device, including a smartphone, among other external devices. Whether the first PCBA 130a can communicate directly with the external hardware management system 137 over a network 146, or utilize the external device 140 to communicate with the external hardware management system 137 can, at least partially, depend on the configuration or capabilities of the communication device 142. For example, the communication device 142 may be configured to accommodate communications using only a first communication protocol, such as, for example, Bluetooth Low Energy, that may necessitate indirect communications between the first PCBA 130a and the external hardware management system 137. However, according to other embodiments, the communication device 142 may support other communication protocols, such as, for example, Wi-Fi and/or Thread, among others, such that the first PCBA 130a can selectively communicate with the external hardware management system 137 over a corresponding Wi-Fi, IP-based mesh network, or cellular network 146, among other networks.

In the illustrated example, the plurality of PCBAs 130a-d can further include a second PCBA 130b, which, in this example, can be a chassis core PCBA 130b. Further, as seen in the illustrated example, the second PCBA 130b can, in addition to being communicatively coupled to the first PCBA 130a, also be part of the inner escutcheon 106. Further, the illustrated second PCBA 130b can be configured to control what can be deemed the more product centric features than behavior centric features of the door lock assembly 100, or otherwise referred to as relating to lowest-level product features, of the electronic system 122 and/or door lock assembly 100. Such features can include, for example, power distribution and management for the electronic system 122, including, for example, with respect to power distribution to the other PCBAs 130a, 130c, 130d. Thus, as seen in FIG. 2, the second PCBA 130b can be couple to the power source 120. Such low-level product features can also relate to the second PCBA 130b being utilized in controlling the activation and deactivation of the actuator 118, including the supply and distribution of power to the actuator 118 in a manner that can be utilized to control the bolt of the bolt portion 108 from being displaced between the extended/locked and retracted/unlocked positions. An additional example of the second PCBA 130b being used with such low-level features can include the second PCBA 130b including, or otherwise being coupled to, one or more sensors 144 that can provide information regarding a status of one or more aspects of the electronic system 122 and/or door lock assembly 100. For example, with certain embodiments, the second PCBA 130b can receive information from a sensor 144 that indicates whether a cover for the power supply 120, such as, for example, one or more batteries, is, or is not, in a closed position, among other types of sensed information.

In the illustrated example, one or more of the PCBAs 130a-d can store product information that may be specific to the particular, or specific, product 50. A variety of criteria can be used in determining which the PCBAs 130a-d, or the associated memory device 134, is to store such product specific information. For example, according to certain embodiments, a determination can be made as to which PCBA 130a-d is least likely to be removed from the electronic system 122 and/or corresponding product 50 in at least an attempt to enhance the likelihood that such product specific information will not be removed from associated electronic system 122 and/or corresponding product 50. For example, such a decision may be based on which PCBA 130a-d performs the most lock specific features, which again can correspond to the lowest level features product, which, as discussed above, in this example is the second PCBA 130b. Thus, according to certain embodiments in which the second PCBA 130b is the least likely of the PCBAs 130a-d to be removed from the door lock assembly 100, the memory device 134 of the illustrated second PCBA 130b can store, among other information, product identification information, including information that is uniquely specific to the particular door lock assembly 100 and/or the associated electronic system 122. In these regards, the second PCBA 130b can also be referred to as the Product PCBA.

Further, the memory device 134 or other portion of the second PCBA 130b can store one or more hardware data-tokens, referred to below as a challenge token, that can be utilized as a level of security during authorized upgrade sequences involving a modification of one more configurable hardware components of the electronic system 122.

As mentioned above, according to certain embodiments, in addition to, or in lieu of, one or more PCBAs 130a, 130b being part of the inner escutcheon 106, one or more PCBAs 130c, 130d can also be part of the outer escutcheon 104. For example, in the illustrated embodiment, a third PCBA 130c and a fourth PCBA 130d can be part of the outer escutcheon 104. According to certain embodiments, the third PCBA 130c can be a surface core PCBA that can be configured to be used in connection with a user interfacing with the product 50 (e.g., door lock assembly 100), and, moreover, the electronic system 122. Thus, while the third PCBA 130c is illustrated in FIG. 2 as being separate from the credential portion 116, the third PCBA 130c can include, be a portion of, or otherwise coupled to at least a portion of the credential portion 116 or of an assembly that includes the credential portion 116. For example, according to certain embodiments, the third PCBA 130c can be communicatively and/or physically coupled to the credential portion 116 of the electronic system 122 in a manner that can interface with the user. For example, according to embodiments in which the credential portion 116 is a keypad, the third PCBA 130c can include keypad touchpoints that are positioned behind, or otherwise coupled to, keys of the keypad. Additionally, or alternative, the third PCBA 130c can include one or more antennas that can be utilized to receive, and/or retrieve, credential data from a credential of a user, including, but not limited to, form a keycard. The third PCBA 130c can also be configured to generate one or more signals to visually communicate with the user, including, for example, via one or more lights or displays that may, or may not, be part of the third PCBA 130c.

In the exemplary embodiment, the fourth PCBA 130d can be an access core PCBA that can be configured, for example, for processing credential data that may be received via the credential portion 116 of the electronic system 122 and/or provided to the fourth PCBA 130d from the third PCBA 130c. Further, the fourth PCBA 130d can also be configured for thru door communication with the first PCBA 130a, including, for example, with respect to communicating processed credential data that the first PCBA 130a can use in connection with the above-mentioned access decisions.

As mentioned above, while the illustrated example discusses configurable hardware components in the form of four PCBAs 130a-d, the types of configurable hardware components, as well as the number of configurable hardware components can vary. For example, according to certain embodiments, the electronic system 122 can include one or more expansion ports configured for selective addition of additional, or other, PCBAs, including, for example, other PCBAs that can be communicatively coupled to one or more existing PCBAs 130a-d.

FIG. 2 also provides an example of an external hardware management system 137 that can, according to certain embodiments, can comprise, for example, at least the cloud 138. As previously discussed, in the illustrated embodiment, the cloud 138 can be configured to be responsible for managing at least certain aspects of an upgrade sequence, including, for example, determining the correct firmware versions, including combinations of firmware versions, and configurations for the product 50, based on the combination of hardware components of the electronic system, and/or a particular application for the associated product 50, including, but not limited to, whether the product is to configured to provide at least certain functionality associated with commercial use of the product 50 as opposed to residential use, or vice versa. Additionally, according to certain embodiments, the cloud 138 can include one or more processors to which data from the product 50, including associated configurable hardware, is directly or indirectly communicated. According to such an embodiment, the communicated data, also referred to as information, communicated to the cloud 138 can be interpreted by one or more processors, including, but not limited to, via one or more encoded data fields being interpretated by one or more programs running on at least one processor of the cloud 138.

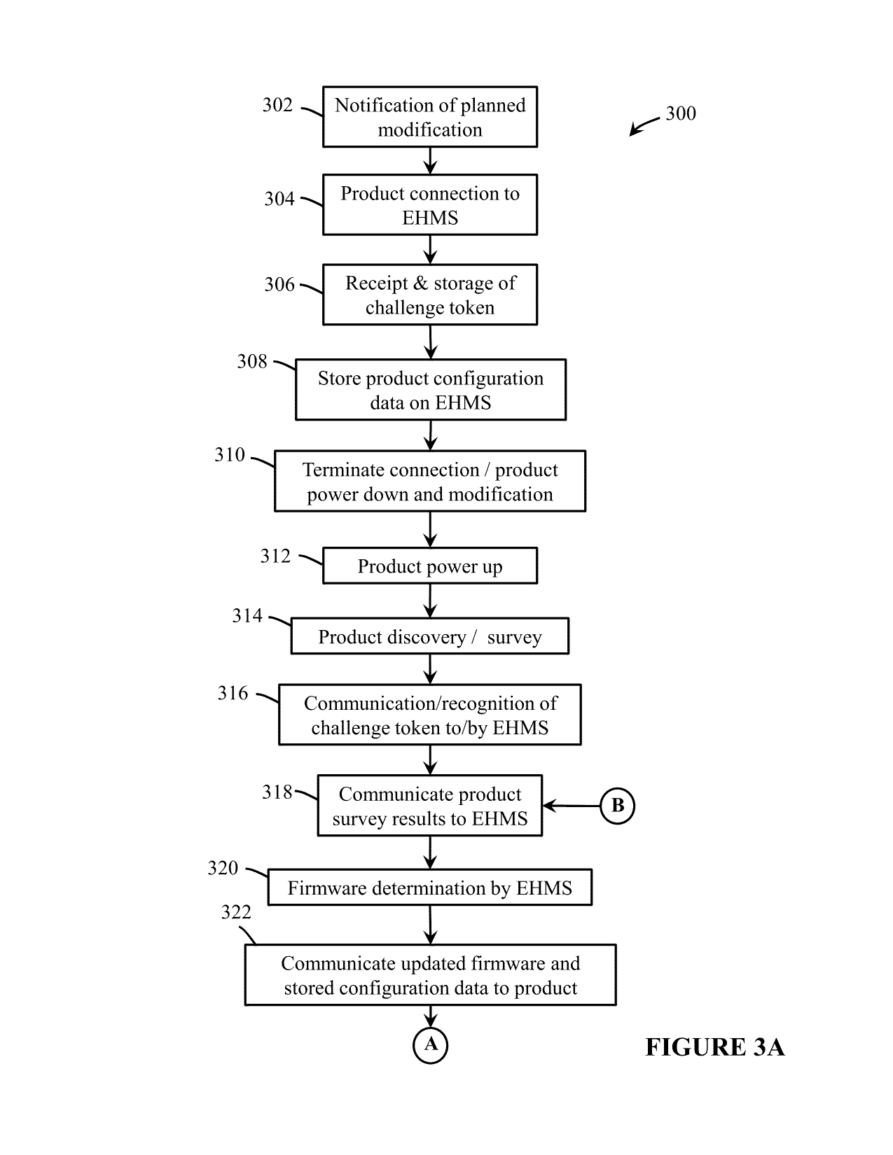

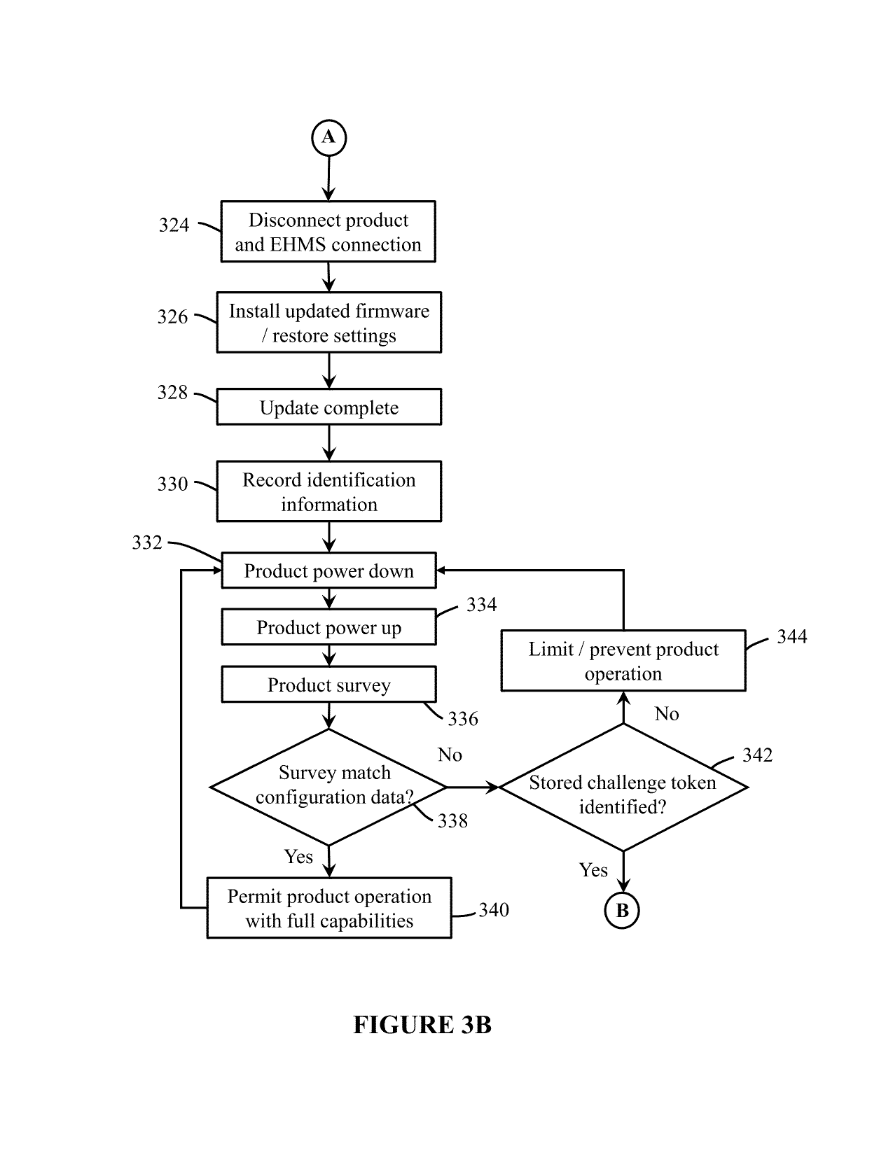

The external device 140 can at least be configured to accommodate communications between the product 50 and the user, the user and the external hardware management system 137, and/or to facilitate communications between the product 50 and the external hardware management system 137. For example, as discussed below with respect to at least FIG. 3A, according to certain embodiments, the external device 140 device can be used by the user to initiate an upgrade sequence for the product, including, for example, via communicating a notification to the external hardware management system 137 that the product 50 will be undergoing a modification at least with respect to the electronic system 122. Further, as discussed above, according to certain embodiments, depending on the communication abilities or protocols utilized by the electronic system 122, including, for example, the communication unit 142, the external device 140 can assist the door lock assembly 100 with connecting to in network 146 such that the external hardware management system 137 and product 50 can be communicatively coupled through at least the external device 140. The external device 140 can comprise a variety of different types of computing devices, including, but not limited to, mobile computing devices such as, for example, a smartphone or tablet having an appropriate software application (e.g., “app”) installed thereon, among other computing devices and systems.

FIGS. 3A and 3B illustrate a simplified flow diagram of an exemplary method 300 for modifying, including, for example, replacing, repairing and/or upgrading, one or more configurable hardware components of a configurable electronic system. In some instances, the repair can involve replacing an existing hardware component with an equivalent or same type of hardware component, while the replacement and/or upgrade can involve replacing a prior hardware component with a hardware component having different capabilities. The method 300 is described below in the context of being carried out by the illustrated exemplary system 150. However, it should be appreciated that method 300 can likewise be carried out by any of the other described implementations, as well as variations thereof. Further, the method 300 corresponds to, or is otherwise associated with, performance of the blocks described below in the illustrative sequence of FIGS. 3A and 3B. It should be appreciated, however, that the method 300 can be performed in one or more sequences different from the illustrative sequence. Additionally, one or more of the blocks mentioned below may not be performed, and the method 300 can include steps or processes other than those discussed below.

As illustrated below, the method 300 can involve using an external hardware management system 137 that is configured for customizing the firmware, among other software, that is be utilized by the product 50 to be specific to the identified hardware configuration of the associated electronic system 122. Again, such an approach can allocate responsibility to the external hardware management system 137 to determine, and customize, the collection of compatible firmware, including firmware package or image, for a particular combination of identified hardware components. Further, such automatic customization of the firmware delivered to the product 50 can accommodate the product 50 receiving from the external hardware management system 137, and storing, only the firmware required for the functional operation of the intended capabilities and features of the product 50. As demonstrated below, such an approach can be achieved with minimal, if any, interaction by the user of the product 50.

FIGS. 3A and 3B also illustrate a secure manner to attain a survey of at least discoverable configurable hardware components of an electronic system 122, determine if there has been a change, such as, for example, an addition, removal, and/or replacement, of hardware components to/from the electronic system 122, and securely identify if such a change(s) is, or is not, part of an authorized upgrade sequence for the product 50. Such an approach can provide for the electronic system 122 to determining whether the electronic system 122 is in the midst of undergoing a credible upgrade sequence, including an authorized modification, or may instead have potentially been the subject of a tampering event. Further, in response to the detection of possible tampering with the electronic system 122, the electronic system 122 can limit the available capabilities of the product 50, if not shut down the electronic system 122 and/or product 50, at least until a prior hardware configuration for the product 50 has been restored and detected by the electronic system 122.

As seen in FIG. 3A, at block 302, the external hardware management system 137, such as, for example, the cloud 138, can be notified of a planned or upcoming modification for the product 50. For example, via use of the external device 140, including, for example, use of an app on a smartphone or tablet, a user can input information that is communicated to the cloud 138 indicating an upcoming modification of one or more configurable hardware components of the product 50, such as, for example, repairing or replacing one or more, but not necessarily all, of the PCBAs 130a-d. According to certain embodiments, such notification at block 302 can include an identification of the particular product 50 that will be undergoing the modification. Optionally, the notification can also include an indication of the modification that will be occurring, such as, for example, identify a particular PCBA 130a-d that is being replaced, repaired, and/or added to the electronic system. However, such detail regarding an indication of the type of modification, or identification of the particular hardware component(s) involved in the modified can also be unnecessary, as such an identification of the modification can be determined in other manners during the method 300, as discussed below. For example, an identification of the particular modification made to the product 50 can be determined, for example, in connection with a controller (e.g., PCBA 130a) of the electronic system 122 and/or the cloud 138 evaluating the results of a survey of the electronic system 122, as discussed below for example in connection with at least blocks 314 and 340.

At block 304, the external hardware management system (EHMS) 137, such as, for example, the cloud 138, can establish a direct or indirect first, or initiation, communication connection with the product 50, or vice versa, through use of at least the network 146. As previously discussed, whether the product 50 directly or indirectly connects with the cloud 138 can be based on a variety of different criteria, including, the communication capabilities of the product 50. With the initiation connection established, the external hardware management system 137 can, as indicated by block 306, communicate a challenge token that is stored on the product 50 (e.g., door lock assembly 100). The challenge token can be a temporary security key or other token data that is used in connection with securely reestablishing a second communication connection between at least the external hardware management system 137 and the product 50 after completion of the modification of the product 50, as discussed below. Moreover, the challenge token may be temporary in that the challenge token may, after a predetermined time period, be deemed by the at least the external hardware management system 137 to have expired, and thus no longer be valid. Accordingly, the challenge token may only be successfully used in a subsequent challenge sequence involving the external hardware management system 137 and the electronic system 122 of the product 50 for limited amount of time so as to prevent later use of the challenge token in connection with unauthored modifications to, including tampering with the product 50. Further, as discussed above, the challenge token can be stored at a variety of memory locations of the product 50 or associated electronic system 122, including being stored on the hardware component that is the least likely of the configurable hardware components to be replaced, which, again, in this example is the second PCBA 130b.

During the first, or initiation connection, to the extent not already stored or otherwise available to the external hardware management system 137, at block 308 the product 50 can communicate product settings data to external hardware management system 137. Such product settings data may be communicated to the external hardware management system 137 for at least temporary storage by the external hardware management system 137 while the product 50 undergoes the modification. A variety of different types of information can be temporarily stored by the external hardware management system 137 as the product settings data. For example, product settings data communicated to, and stored by, the external hardware management system 137 can correspond to configurations or settings of the associated product 50 that had/have been set or selected by the user of the product 50. For example, such stored product settings data can include settings relating to user preferences, such as, for example, relock and brightness settings for I/O devices of the product 50, among other user selected settings. Additionally, the stored product settings data can include database contents and audit logs, such as, for example, a current database of users and/or the identification numbers (PIN) or codes established for using with the product 50, among other information. Alternatively, according to other embodiments, including, embodiments, in which the product 50 regularly, or at least periodically, connected to the external hardware management system 137, such product settings data can normally be stored at both the product 50 and the external hardware management system 137, in which case block 308 may be unnecessary, or utilized for other purposes, including comparing current product settings data versus to the existing product settings data stored at the external hardware management system 137. Moreover, the product settings data stored at block 308 can correspond to at least configuration information for the product 50 that may be set at least at initial installation of the product 50, such that the user does not have to undergo a similar configuration procedure following the modification of the product 50. Additionally, as discussed below, whether all of the product settings data stored by the external hardware management system 137 at block 308 is subsequently returned to the product 50 after the modification of the product 50 can be based on an evaluation by the hardware management system 137 as to whether at least certain the corresponding such product settings are still applicable in view of the type of modification that has occurred at the product 50.

According to certain embodiments, following receipt of the challenge token by the product 50 (block 306), as well as the storage of product settings data at the external hardware management system 137 (block 308), the external hardware management system 137 can communicate a signal for the product 50 that indicates to the product 50 that modification of the product 50, and, more specifically, the electronic system 122, can begin. The initiation connection between at least the product 50 and the external hardware management system 137 can then be terminated, and the product 50 be powered down at block 310, such as, for example, electrically deactivated. Additionally, as seen in FIG. 3A, at block 310 modification of the product 50 can commence. As previously mentioned, such modification at block 310 can, for example, involve one or more of repairing, replacing, and or updating, one or more configurable hardware components of the electronic system 122, such as, for example, one or more of the PCBAs 130a-d.

Upon completion of the modification of the product 50, the product 50, and more specifically the modified electronic system 122 can, at block 312, be powered up or on, including, for example, electrically activated. The powering up of the product 50 can, among other trigger events, facilitate the controller (e.g., first PCBA 130a) to initiate discovery or query for the above-mentioned common memory regions of each of the configurable hardware components (e.g., PCBAs 130a-d). Such discovery can be performed using a variety of hardware discovery or query protocols, including, for example, inter-integrated circuit (I²C or I2C), universal asynchronous receiver / transmitter (UART), or serial peripheral interface (SPI), among other protocols or techniques. Such discovery of the common memory regions of the configurable hardware components can include searching known or anticipated I2C address areas, and/or conducting queries or surveys of other memory spaces. Moreover, the discovery or querying for the common memory regions involves locating a relatively small, and possibly known, number of common memory regions corresponding to each configurable hardware component, which, in this example, is at least the PCBAs 130a-d. Further, the PCBAs 130a-d can have some consistency with respect to at least the memory structures of the memory devices 134 and/or processing devices 132 having the common memory region, which can further enhance the speed at which the common memory regions are discovered.

In connection with the discovery of the common memory regions of the configurable hardware, block 314 can also include surveying identification information stored at the discovered common memory regions. Such a survey can include, for example, obtaining identification information that identifies, for example, the type, part number, manufacturing location, manufacturing date, revision, and unique serial number of the associated configurable hardware (e.g., PCBA 130a-d), among other information that may be relevant to the identification, discovery, updating, and configuration solutions discussed herein. The result of the survey, also referred to as a survey report, can at least provide an indication of what hardware, or combination of hardware, are connected to the components of the electronic system 122. Further, at least some of the information obtained by the survey can be of the type that is utilized by at least the external hardware management system 137 to determine the particular firmware, including firmware package or image, that is to be used by the combination of discovered configurable hardware components and/or associated features or capabilities of the electronic system 122 and/or product 50. Additionally, the survey report can also provide information that can be used by the external hardware management system 137 and/or a controller of the product 50 to identify the changes, including changes with respect to new, different, and/or missing hardware components to the electronic system, 122. As discussed below, such identification of changes to the hardware components can at least be utilized in attempts to prevent unauthorized changes, including tampering, with the operation of the product 50.

At block 316, the second communication connection can be directly or indirectly established between the external hardware management system 137 and the product 50 and/or electronic system 122. For at least purposes of security, at, or around the onset of the second communication connection, the product 50 can provide to the external hardware management system 137 the challenge token that had previously been provided by external hardware management system 137 at block 306. Accordingly, at block 316, the external hardware management system 137 can evaluate the received challenge token. Such an evaluation can include authenticating the challenge token, including determining whether the challenge token was, or was not, received by the external hardware management system 137 at block 316 within a predetermined time so as to still be valid. According to certain embodiments, if the external hardware management system 137 determines that the challenge token was not timely received by, or returned to, the external hardware management system 137 the external hardware management system 137 may terminate the second communication connection. Further, in such an event, the modifications made to the product 50 at blocked 312 may have to be undone so that the product 50 is returned to its prior, unmodified or original condition, and the method 300 may need to be restarted at block 302.

If at block 316, the external hardware management system 137 authenticates the challenge token, including determines the challenge token has been timely received by the external hardware management system 137, then the upgrade sequence can proceed to block 318. According to certain embodiments, in response to authenticating the challenge token, the external hardware management system 137 can provide an indication to the product 50, including the electronic system 122, that the upgrade sequence can continue, including proceed with respect to the survey report being communicated to the external hardware management system 137. At block 318, the controller (e.g., the first PCBA 130a) can generate one or more signals for the transmission of the survey report that was obtained at block 314 to the external hardware management system 137.

Optionally, according to certain embodiments, the external hardware management system 137 can store a prior survey report(s) or other information that the external hardware management system 137 can use in evaluating the product survey communicated at block 318 to identify, at block 320, changes, if any, to the electronic system 122, as well as the nature of the changes. Such a determination at block 320 can assist the external hardware management system 137 in determining whether the identified change(s), if any, to the electronic system 122 necessitates an update in the firmware used by the electronic system 122. Moreover, an identification of changes, if any, with respect to a configurable hardware component(s) of the electronic system 122 can assist the external hardware management system 137 with determining at block 320 the updated firmware, including firmware package or image(s), that is to be installed on the electronic system 122. Such a determination of the updated firmware for the modified electronic system 122 can include the external hardware management system 137 performing at block 320 a compatibility determination(s) to identify and customize the updated firmware that is to be used by the product 50. Such compatibility and identification of the updated firmware for the electronic system 122 can be performed in a variety of manners, including, for example, by one or more algorithms stored on, or accessed by, the external hardware management system 137. Thus, such algorithms can be configured for selecting the proper updated firmware revisions and configurations to install in one or more of the configuration hardware components, and any other software configuration that may be optimal for a functional product 50 that is operable with the full range of intended capabilities. Further, the updated firmware determination can be based on a variety of different criteria, including, for example, the associated processing device 132 of the various identified configurable hardware products.

At block 322, the updated firmware, including, for example, firmware package or image(s), among other software determined at block 320 can be communicated from the external hardware management system 137, and be received by the product 50. The communication at block 322 can also include at least some, if not all, of the product settings data for the product 50 that were stored on the external hardware management system 137 at block 306 be communicated back to the product 50. However, according to certain embodiments, the firmware determination at block 320 by the external hardware management system 137 can further include, or result in, the external hardware management system 137 identifying at least portions of the product settings data that was stored at the external hardware management system 137 that may no longer be relevant or useful to the product 50 based on the hardware modification(s) that occurred at block 310. For example, at least certain product settings data that was stored at block 306 may, based on the modification of the product 50 that occurred at block 310, relate to configurable hardware components or features that are no longer part of the product 50 or have been changed in a manner that render particular portions or aspects of such product settings data no longer relevant or applicable to the operation of the electronic system 122 and/or product 50. Accordingly, with respect to the previously stored product settings data, the communication at block 322 can include the external hardware management system 137 identifying at least some of the product settings data that will not be communicated back to the electronic system 122 and/or product 50.

With the updated firmware and product settings data communicated from the external hardware management system 137 to the product 50, the second communication connection between the external hardware management system 137 and the product 50 can be terminated or otherwise ended at block 324. At block 326, the electronic system 122 of the product 50, including, for example, a controller (e.g., first PCBA 130a) can perform an update of the electronic system 122 by installing the updated firmware that was received from the external hardware management system 137 at block 322. Such an update can include, for example, recording, at one or more common memories of the configurable hardware components, information regarding the updated firmware that is being installed at block 326. Additionally, at block 326, the stored product settings that had been at least temporarily stored at the external hardware management system 137, including, for example, previously set user preferences, data, and logs, and that was communicated to the product at block 322, can be restored at the product 50.

At block 330, information identifying the current hardware components of the electronic system 122, or aspects thereof, can be stored on the product 50, including, for example, on the memory device 134 of the controller (e.g., first PCBA 130a). According to certain environments, this hardware inventory can correspond to the information that was obtained during the survey that was performed at block 314, or provided in connection with the information communicated by the product 50 from the external hardware management system 137 at block 322, among other items. The hardware inventory can comprise a variety of different types of information or identifiers in maintaining a record at the product 50 of the at least the configurable hardware components that are, or are currently expected to be, part of the electronic system 122, including, but not limited to, serial numbers for the configurable hardware components (e.g., PCBAs 130a-d), among other hardware. As discussed below, such stored identification information, or hardware inventory, for the configurable hardware components can at least be utilized in connection with detecting alterations to, including potential tampering with, the electronic system 122.

To the extent the product 50 is not being actively operated or engaged, at block 332 the product 50 and/or electronic system 122 can be powered down, including, for example, powered down, electrically deactivated, or placed in a hibernation mode. A subsequent awakening from the hibernation mode or powering on of the product 50 and/or electronic system 122 at block 334 can, at block 336, trigger the controller (e.g., first PCBA 130a) to initiate a discovery sequence similar to that which was conducted at block 314. Moreover, at block 336 the discovery and survey sequence can occur that at least provides an identification of at least the configurable hardware components that are currently connected to the electronic system 122. Further, at block 338, the controller (e.g., first PCBA 130a) can evaluate the results of the survey obtained at block 336 with the hardware inventory that was recorded at block 330 in connection with determining whether there has been a change to the electronic system 122, including a subsequent modification relating to one or more configurable hardware components. If such an evaluation indicates there has been no change to the electronic system 122, then the product 50 can proceed with normal operation at block 340, including, for example, operation using the full capabilities of the product 50.

If, however, the evaluation at block 338 indicates there has been a change to at least one or more configurable hardware components of the electronic system 122, then the controller (e.g., PCBA 130a) can determine at block 342 whether the difference is associated with a credible upgrade sequence or may instead possibly be associated with a tampering event or other improper attempt at modifying the product 50. Whether the difference(s), if any, identified block 342 is/are associated with a credible upgrade sequence can be determined in a variety of manners. For example, with respect to a credible upgrade sequence, the differences identified at block 342 can be associated with the performance of at least blocks 302-314 during performance of the method 300. Thus, determining whether differences identified at block 342 are associated with a credible upgrade sequence can include, for example, determining whether a current, or relatively recently received, challenge token is stored by at least one memory device within the electronic system 122, as identified by block 342. If such a stored challenge token is discovered or identified at block 342, then the differences identified at block 338 may be part of a credible challenge sequence, in which event the method 300 can proceed to 316 for authentication of the challenge token by the external hardware management system 137, and performance of the associated steps relating to upgrading the firmware, as previously discussed.

Conversely, the absence of an identification of a challenge token at block 342 can indicate a potential illicit tampering with, or other erroneous attempt to modify, the product 50. Thus, in such situations, the method 300 can proceed to block 344, wherein the controller (e.g., PCBA 130a) can be utilized to limit the operability, including operable functions or capability, of the product 50. Alternatively, in response to an indication at block 342 that the hardware change may be unauthorized or improper, the method 300 can proceed to block 332, wherein the product 50 can be powered down. In such situations, subsequent attempts to use the product 50 can require that the hardware of the product 50 be restored to the configuration associated with the identification information recorded at block 330, and that at least the process outlined by at least blocks 302 through 308 be followed before the product 50 again undergoes a modification. Additionally, or alternatively, in situations in which the operation of the product 50 is limited at block 344, basic configuration data or information provided by a memory device 134 of a new or replacement configurable hardware component(s) that has not yet been authenticated as being part of an authorized modification can be provided to one or more processing devices 132 of the product 50 in connection with informing that processing device 132 as to how to configure product 50 for, at least temporary, the safe operation of the product 50, as previously discussed. Again, as discussed above, such safe operation can relate to partial, or limited, but not necessarily full, functionality of the product 50. Additionally, as previously discussed, such basic configuration provided for the safe operation of the product 50 can also include information that can instruct the main processing element (e.g. the controller or first PCBA 130a) how to discover other new or replacement items, including other configurable hardware component(s), that may also be connected to the product 50, as previously discussed.

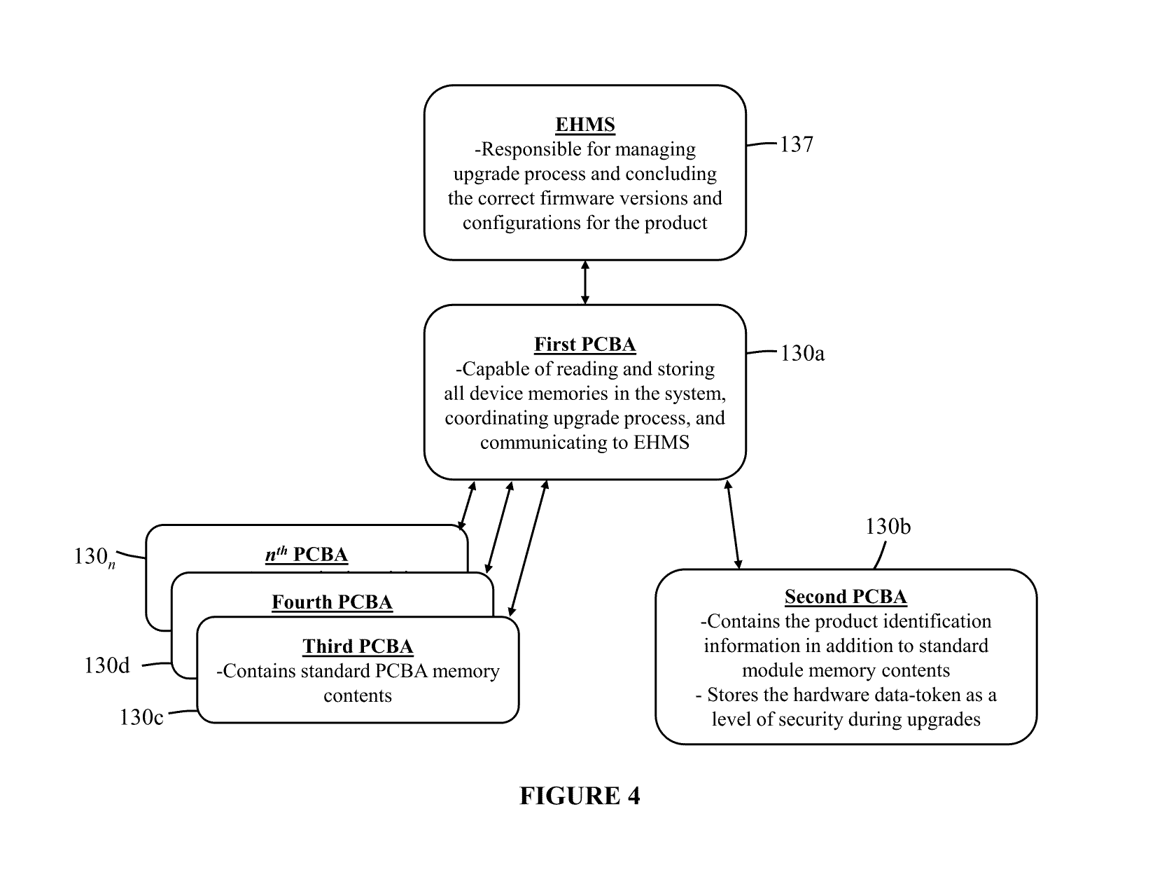

FIG. 4 illustrates a simplified block diagram depicting features relating to configurable hardware components, in this example up to an n th number of PCBAs, of the illustrated product 50 and an associated external hardware management system 137. As seen in this example, the first PCBA 130a is configured to read and to communicate with each of the other PCBAs 130b-d of the product 50, as well as communicate with the external hardware management system 137, such as, for example, the cloud 138. Moreover, in the illustrated example, the first PCBA 130a can operate as a controller for the product 50 that can control the behavior of the product 50, as well as perform decision making at least with respect to communications with the external hardware management system 137. Further, as seen in FIG. 4, in the illustrated example, the first PCBA 130a is configured to control, and/or perform, the discovery of the common memory regions contained on at least the other configurable hardware components (e.g., PCBAs 130b-d), as well as surveying those common memory regions to obtain identification information for those configurable hardware components (PCBAs 130b-n), as discussed above, including, for example, with respect to at least block 314 in the method 300 shown in FIGS. 3A and 3B. Further, as discussed above, product identification information, such as, for example, information identifying the product 50, can be stored on the configurable hardware component that is least likely to be removed from the product 50, which, in the illustrated embodiment, is the second PCBA 130b.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A system comprising:
a door lock assembly;
an electronic system housed within at least a portion of the door lock assembly, the electronic system comprising
a plurality of configurable hardware components, each of the plurality of configurable hardware components having at least a common memory region;
at least one processor;
a memory coupled with the at least one processor, the memory including instructions that when executed by the at least one processor cause the at least one processor to:
discover the common memory region for each configurable hardware component of the plurality of configurable hardware components;
survey the common memory region of each configurable hardware component of the plurality of configurable hardware components for an identifier;
transmit a survey report for an external hardware management system that is external to the door lock assembly that identifies each of the plurality of configurable hardware components based at least in part on the identifier;
receive an updated firmware generated by the external hardware management system that is based on the combination of the plurality of configurable hardware components identified by the survey report; and
install the updated firmware on each of the plurality of configurable hardware components.

2. The system of claim 1, wherein the door lock assembly comprises a bolt portion, an inner escutcheon, and an outer escutcheon.

3. The system of claim 1, wherein the memory further includes instructions that when executed by the at least one processor cause the at least one processor to:
generate a signal to facilitate a storage, by the electronic system, of a challenge token provided by the external hardware management system during a first communication connection involving the electronic system and the external hardware management system; and
generate a signal for a transmission of the challenge token for the external hardware management system during a second communication connection involving the electronic system and the external hardware management system,
wherein the memory further includes instructions that when executed by the at least one processor cause the at least one processor to transmit the survey report to the external hardware management system in response to the challenge token being validated by the external hardware management system.

4. The system of claim 3, wherein the memory further includes instructions that when executed by the at least one processor cause the at least one processor to:
power down the electronic system at least after storage of the challenge token; and
initiate at least a survey of the common memory region of each configurable hardware component after the electronic system is powered on at a time after the power down of the electronic system.

5. The system of claim 4, wherein the memory further includes instructions that when executed by the at least one processor cause the at least one processor to:
generate a signal for a transmission during the first communication connection of a plurality of product settings data for storage on the external hardware management system, the plurality of product settings data including at least one user defined preference for an operation of at least one of the plurality of hardware components; and
receive during the second communication connection at least a portion of the plurality of product settings data that were stored on the external hardware management system.

6. A system comprising:
an electronic system housed within at least a portion of a product, the electronic system comprising
a plurality of configurable hardware components, each of the plurality of configurable hardware components having at least a common memory region;
at least one processor;
a memory coupled with the at least one processor, the memory including instructions that when executed by the at least one processor cause the at least one processor to:
discover, in response to a trigger event, the common memory region for each configurable hardware component of the plurality of configurable hardware components;
survey the common memory region of each configurable hardware component of the plurality of configurable hardware components for an identifier;
generate a survey report that identifies each of the plurality of configurable hardware components based at least in part on the identifier;
compare the survey report to a hardware inventory stored by the electronic system;
identify, in response to at least an identification of a difference between the survey report and the hardware inventory, a stored information indicative of the product undergoing an authorized upgrade sequence;
transmit, in response to at least identification of the stored information indicative of the authorized upgrade sequence, the survey report for an external hardware management system that is external to the product;
receive an updated firmware generated by the external hardware management system that is based on the combination of the plurality of configurable hardware components identified by the survey report; and
install the updated firmware on each of the plurality of configurable hardware components.

7. The system of claim 6, wherein the memory further includes instructions that when executed by the at least one processor cause the at least one processor to:
limit a capability of, or power down, the electronic system in response to an absence of a detection on the electronic system of the stored information indicative of the product undergoing an authorized upgrade sequence, and wherein the survey report is not transmitted in the absence of the detection of the stored information indicative of the authorized upgrade sequence.

8. The system of claim 6, wherein the memory further includes instructions that when executed by the at least one processor cause the at least one processor to:
receive during a first communication connection involving the electronic system and the external hardware management system, a challenge token provided by the external hardware management system;
transmit, during the first communication connection, a product settings data for storage on the external hardware management system, the product settings data comprising at least one user defined setting for an operation of at least one of the plurality of configurable hardware components;
power down the electronic system after at least receipt of the challenge token and transmission of the product settings data; and
receive, in response to the challenge token being authenticated by the external hardware management system, at least a portion of the product settings data during a second communication connection during which the updated firmware is received by the electronic system.

9. The system of claim 8, wherein the trigger event comprises the electronic system being powered on, and wherein the stored information indicative of the product undergoing an authorized upgrade sequence is the challenge token.

10. A method comprising:
discovering, using a controller of a product, a common memory region for each of a plurality of configurable hardware components of an electronic system of the product;
surveying, using the controller, the discovered common memory region of each configurable hardware component of the plurality of configurable hardware components for an identifier;
transmitting, from the electronic system and during a first communication connection, a survey report for an external hardware management system that is external to the product, the survey report identifying each of the plurality of configurable hardware components based at least in part on the identifier;
receiving, by the electronic system, an updated firmware generated by the external hardware management system that is based on the combination of the plurality of configurable hardware components identified by the survey report; and
installing the updated firmware on each of the plurality of configurable hardware components.

11. The method of claim 10, wherein the product is a door lock assembly.

12. The method of claim 10, further comprising:
storing, by the electronic system, a challenge token during the first communication connection involving the electronic system and the external hardware management system;
transmitting, during a second communication connection, the challenge token from the electronic system and for the external management system, the second communication connection being established after at least the first communication connection has been terminated; and
wherein the survey report is transmitted to the external hardware management system in response to the challenge token being validated by the external hardware management system.

13. The method of claim 12, further comprising powering down the electronic system after at least storing the challenge token,
wherein the surveying of the discovered common memory region of each configurable hardware component occurs after the electronic system is powered on at a time after the powering down of the electronic system.

14. The method of claim 13, further comprising:
transmitting from the electronic system during the first communication connection a product settings data for storage on the external hardware management system, the product settings data including at least one user defined preference for an operation of at least one of the plurality of hardware components; and
receiving, by the electronic system, during the second communication connection, at least a portion of the product settings data that was stored on the external hardware management system.

15. The method of claim 14, wherein the product settings data received by the electronic system is a modified version of the product settings data that was previously communicated to the external hardware management system.

16. The method of claim 10, further comprising:
comparing by the controller, prior to communicating the survey report to the external management system, the survey report to a hardware inventory stored by the electronic system;
identifying, when a difference is detected between the survey report and the hardware inventory from the comparison, a stored information indicative of the product undergoing an authorized upgrade sequence, and
generating a signal, by the product, in response to identifying the stored information indicative of the authorized upgrade sequence, to communicate the survey report to the external hardware management system.

17. The method of claim 16, further comprising:
limiting a capability of, or powering down, the electronic system in response to not identifying the stored information indicative of the authorized upgrade sequence, and wherein the survey report is not transmitted from the product in the absence of identifying the stored information indicative of the authorized upgrade sequence.

18. The method of claim 17, wherein the stored information indicative of the authorized upgrade sequence is a challenge token that was received by the electronic system.

19. The method of claim 10, further comprising:
receiving, by the electronic system during a first communication connection involving the electronic system and the external hardware management system, a challenge token provided by the external hardware management system;
transmitting, from the electronic system during the first communication connection, a product settings data for storage on the external hardware management system, the product settings data comprising at least one user defined setting for an operation of at least one of the plurality of configurable hardware components;
powering down the electronic system after at least receiving the challenge token by the electronic system and transmitting the product settings data; and
comparing by the controller, in response to a trigger event at a time after at least powering down the electronic system and prior to transmitting the survey report, the survey report to a hardware inventory stored by the electronic system;
transmitting, based on a result of comparing the survey report to the hardware inventory, the challenge token for the external hardware management system; and
receiving, in response to the challenge token being authenticated by the external hardware management system, at least a portion of the product settings data during a second communication connection during which the updated firmware is received by the electronic system,
wherein the surveying of the discovered common memory region of each configurable hardware component generates information used for determining if a modification occurred with respect to at least any one of the plurality of configurable hardware components during a time between the powering down and the trigger event.

20. The method of claim 19, wherein transmitting, based on the result of comparing the survey report to the hardware inventory, the challenge token for the external hardware management system comprises:
identifying a difference between the survey report and the hardware inventory; and
identifying information stored on the electronic system indicating at least a portion of the electronic system is undergoing an authorized upgrade sequence.
